(19) United States
(12) Patent Application Publication
(10) Pub. No.: US 2005/0080758 A1
(43) Pub. Date: Apr. 14, 2005

(54) Obtaining a value for a variable that is undefined within one nested procedure

(76) Inventors: Ilia GimeIfarb, Roseville, CA (US); Nehal Patel, Rocklin, CA (US); Sachin N. Chheda, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/681,783

(22) Filed: Oct. 8, 2003

(51) Int. Cl. G06F 7/00

(52) U.S. Cl. 707/1

(57) ABSTRACT

A value is obtained from one or more values from one or more nested procedures, for a variable that is undefined within one procedure that is nested in one or more nested procedures.

### BACKGROUND

A scripting language, for example, the Expect scripting language (http://expect.nist.gov, published by the National Institute of Standards and Technology, 100 Bureau Drive, Stop 3460, Gaithersburg, Md. 20899-3460), is a tool that can be employed to provide for automation of interactive programs, such as file transfer protocol (“FTP”), telnet, and fsck. The Expect scripting language comprises an expect statement. The expect statement comprises one or more result strings. During execution of an interactive program, the interactive program returns one or more responses. The expect statement of one procedure within a program serves to evaluate the one or more responses returned from execution of the interactive program against the one or more result strings of the expect statement. For example, the program serves to invoke the telnet program. The telnet program returns the one or more results, for example, one or more strings. The expect statement serves to match one string (e.g., “login”) returned from the execution of the telnet program to one of the one or more result strings (e.g., “login”, “password”) of the expect statement.

The Expect scripting language defines an expect variable, for example, a timeout variable, at a global scope associated with the program. The expect statement employs a value of the timeout variable to limit a duration of time to wait for the one or more responses returned from the execution of the interactive program (e.g., the telnet program). The expect statement assigns the value of the timeout variable from within a scope associated with the expect statement (e.g., a local scope associated with the one procedure that comprises the expect statement) or employs a value defined at the global scope associated with the program, as will be understood by those skilled in the art. The Expect scripting language in one example comprises a keyword (e.g., “set”) that serves to assign the value to the timeout variable.

### SUMMARY

The invention in one implementation encompasses a method. A value is obtained from one or more values from one or more nested procedures, for a variable that is undefined within one procedure that is nested in one or more nested procedures.

Another implementation of the invention encompasses an apparatus. The apparatus comprises a traversal module that identifies a value for a variable associated with one procedure of one or more values associated with one or more nested procedures. The one procedure is nested in the one or more nested procedures.

Yet another implementation of the invention encompasses an article. The article comprises one or more computer-readable signal-bearing media. The one or more media comprise means for obtaining a value of one or more values from one or more nested procedures, for a variable that is undefined within one procedure that is nested within the one or more nested procedures.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises a host system, a remote system, and a communication medium.

FIG. 2 is a representation of further exemplary details of the host system of the apparatus of FIG. 1.

FIG. 3 is a representation of an exemplary process flow performable by the host system the apparatus of FIG. 1 to invoke one or more commands on the remote system.

FIG. 4 is a representation of further exemplary details of the process flow of FIG. 3 in which an expect module is invoked to execute an expect statement.

FIG. 5 is a representation of further exemplary details of the process flow of FIG. 4 in which a traversal module is invoked to determine a value associated with the expect statement.

FIG. 6 is a representation of one exemplary program of one or more programs invoked by the host system of FIG. 3.

### DETAILED DESCRIPTION

Referring to the BACKGROUND section above, the scripting language restricts the ability for a procedure to be re-used in the automation of the interactive programs. The scripting language in one example obtains the value of the timeout variable from an assignment at the local scope associated with the one procedure within the program or from the value defined at the global scope associated with the program. Where a programmer desires to re-use the one procedure that comprises the expect statement but provide for a different value for the timeout variable, the programmer must modify the code of the one procedure. This requirement of modification of the code undesirably defeats the goal of code reusability.

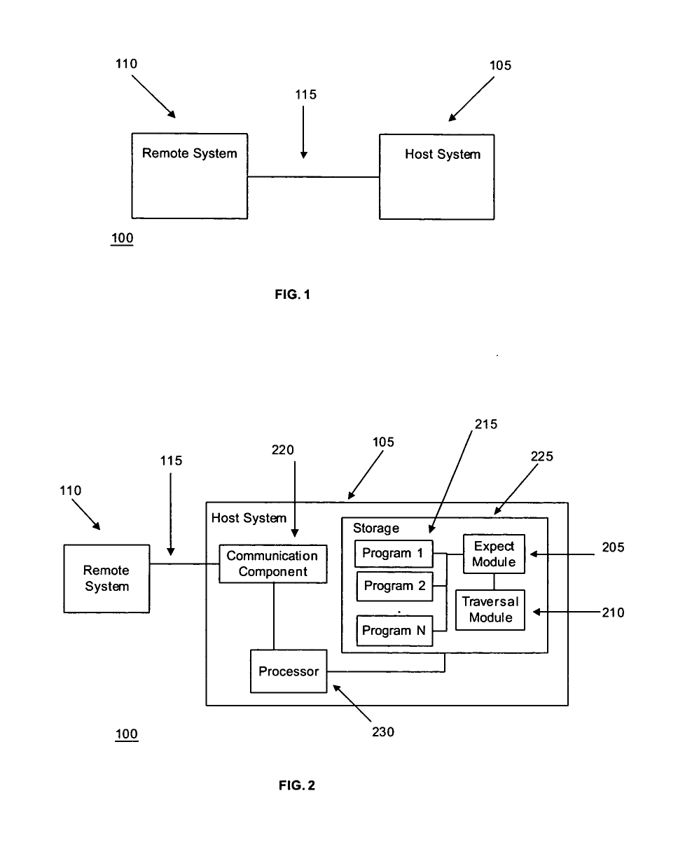

Turning to FIG. 1, an apparatus 100 in one example comprises a plurality of components such as computer software and/or hardware components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

In one example, the apparatus 100 comprises one or more of a host system 105, a remote system 110, and a communication medium 115. In one example, the host system 105 and the remote system 110 are integrated. In a further example, the host system 105 and the remote system 110 comprise a plurality of computers. In one example, the communication medium 115 comprises a twisted pair cable. In another example, the host system 105 and the communication medium 115 are integrated.

The host system 105 communicates with the remote system 110 via the communication medium 115 to invoke one or more commands on the remote system 110. The host system 105 employs a communication protocol, for example, a file transfer protocol (“FTP”) or a telnet protocol, to communicate with the remote system 110 over the communication medium 115. The remote system 110 returns one or more responses to the host system 105 in response to the one or more commands issued by the host system 105.

Referring to FIG. 2, the host system 105 in one example comprises one or more expect modules 205, one or more traversal modules 210, one or more communication components 220, one or more recordable data storage media 225, and one or more processors 230. One or more programs, for example, a program 215, are located on the recordable data storage medium 225. The program 215 comprises one or more procedures, for example, one or more nested procedures. The one or more nested procedures of the program 215 comprise one or more commands and one or more expect statements. The one or more commands of the one or more nested procedures of the program 215 in one example comprise one or more instructions that the host system 105 executes on the remote system 110.

The one or more expect statements of the program 215 in one example define one or more actions to occur based on the one or more responses returned to the host system 105 from the remote system 110, in response to the one or more commands issued by the host system 105. The expect statement in one example defines the one or more actions to occur through definition of one or more result strings, for example, “success” or “failure”, as will be appreciated by those skilled in the art. The expect statement limits a duration of time to wait for the one or more responses by employing the value of the timeout variable.

The communication component 220 establishes communication with the remote system 110 via the communication medium 115. The program 215 executes on the processor 230 and employs the communication component 220 to execute the one or more commands of the program 215 on the remote system 110. The remote system 110 in one example returns the one or more responses to the communication component 220 of the host system 105 via the communication medium 115. During execution of the program 215, the host system 105 invokes an expect module 205.

The expect module 205 in one example serves to extend the Expect scripting language (http://expect.nist.gov, published by the National Institute of Standards and Technology, 100 Bureau Drive, Stop 3460, Gaithersburg, Md. 20899-3460). The expect module 205 extends the Expect scripting language to obtain the value of the timeout value, associated with the expect statement, where the value of the timeout variable is undefined within a local scope associated with the expect statement. The expect module 205 utilizes the Expect scripting language as a library element and invokes the Expect scripting language to process the expect statement of the program 215, as will be appreciated by those skilled in the art.

For example, the processor 230 executes the program 215. Upon execution of one expect statement within the program 215, the processor 230 invokes the expect module 205. The expect module 205 in one example traps the expect statement. The expect module 205 obtains the value of the timeout variable of the expect statement and invokes the Expect scripting language to process the expect statement based upon the value of the timeout variable. The expect module 205 serves to process any results returned from the processing of the expect statement by the Expect scripting language and in one example writes error information into a debug log, as will be appreciated by those skilled in the art.

The expect module 205 obtains the value of the timeout variable of the program 215, where the value of the timeout variable is undefined within the one nested procedure. The expect module 205 invokes the traversal module 210 to identify the value of the timeout variable from one nested procedure of the one or more nested procedures of the program 215. For example, where the one nested procedure omits assigning the value of the timeout variable within a local scope associated with the one nested procedure, the expect module 205 invokes the traversal module 210 to obtain the value of the timeout variable from one nested procedure of the one or more nested procedures of the program 215, as described herein.

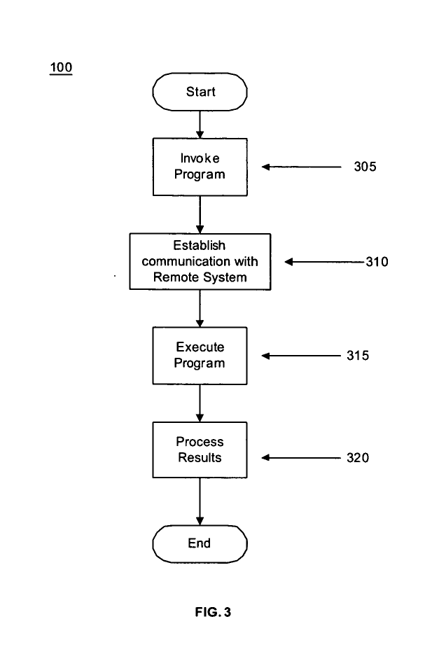

Referring to FIG. 3, in STEP 305 a human operator, a computer device, and/or a computer application, serve to invoke the program 215 on the host system 105, as will be appreciated by those skilled in the art. In STEP 310, the communication component 220 of the host system 105 establishes communication with the remote system 110 via the communication medium 115.

In STEP 315, the host system 105 executes the program 215 on the processor 230. The host system 105 in one example employs the communication component 220 to execute the one or more commands of the one or more nested procedures of the program 215. In STEP 320, the host system 105 in one example processes the one or more responses received from the remote system 110. The host system 105 processes the one or more responses and performs the one or more actions defined by the one or more result strings of the one or more expect statements of the program 215, as described herein.

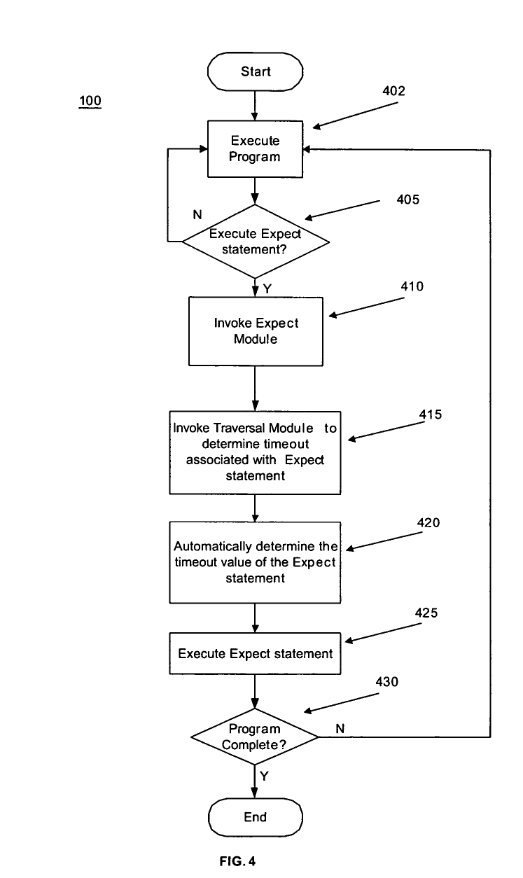

Referring to FIG. 4, in STEP 402, the processor 230 executes the program 215. In STEP 405, the processor 230 executes the procedure of the program 215 that comprises the expect statement. In STEP 410, the host system 105 invokes the expect module 205 upon execution of the expect statement of the procedure of the program 215.

In STEP 415, the expect module 205 determines that the value of the timeout variable associated with the expect statement is undefined within the local scope of the procedure nested within the one or more nested procedures of the program 215. The expect module 205 invokes the traversal module 210 to obtain the value of the variable (e.g., the value of the timeout variable) associated with the one expect statement. In STEP 420, the traversal module 210 automatically determines the value associated with the expect statement and returns the value to the expect module 205. The expect module 205 assigns the value to the timeout variable of the global scope. In the STEP 425, the expect module 205 invokes the library element (e.g., the Expect scripting language) to execute the expect statement of the procedure of the program 215.

The library element (e.g., the Expect scripting language) employs the value of the timeout variable to limit the duration of time to wait for the one or more responses from the remote system 110. The expect module 205 in one example compares the one or more responses to the one or more result strings defined by the expect statement of the procedure of the program 215 and performs the one or more actions associated with the one or more result strings that match the one or more responses. The expect module 205 returns control to the procedure of the program 215 that comprises the expect statement. In STEP 430, the host system 105 executes the program 215 until completion.

In one example, the expect statement of the program 215 comprises a first result string (e.g., “success”) and a first action associated with the first result string (e.g., insert a first message into a debug log), a second result string (e.g., “failure”) and a second action associated with the second result string (e.g., exit the program 215 with error), and a timeout action. In one example, the host system 105 receives one result, for example, a string “success”, from the remote system 110. The expect module 205 matches the one result with the first result string of the expect statement of the procedure of the program 215. The expect module 205 executes the first action associated with the first result string, and inserts the first message into the debug log.

In another example, the host system 105 receives a second result, for example, “failure”, from the remote system 110. The expect module 205 matches the second result with the second result string of the expect statement of the procedure of the program 215 and exits the program 215 with error.

In yet another example, the host system 105 fails to receive the one or more responses from the remote system 110 before reaching an expiration of the duration of time to wait for the one or more responses. The expect module 205 executes the timeout action associated with the expect statement and writes the error message to the debug log.

The expect module 205 in one example determines the expiration of the duration of time by maintaining a timer associated with the expect statement. The expect module 205 limits the timer to the value of the timeout variable. The expect module 205 in one example increments the timer until the first one of either: the expiration of the duration of time (e.g., the timer reaches the one timeout value associated with the one expect statement), or the host system 105 receives the one or more responses from the remote system 110.

Upon reaching the expiration of the duration of time, a timeout occurs and the expect module 205 executes the timeout action. For example, the expect module 205 inserts information such as the timeout value into the debug log. Where the expect module 205 receives the one or more responses before the expiration of the duration of time, the expect module 205 processes the one or more responses. Where the one or more responses match at least one of the one or more result strings associated with the expect statement, the expect module 205 executes the one or more actions associated with the at least one of the one or more result strings and returns control to the procedure of the program 215.

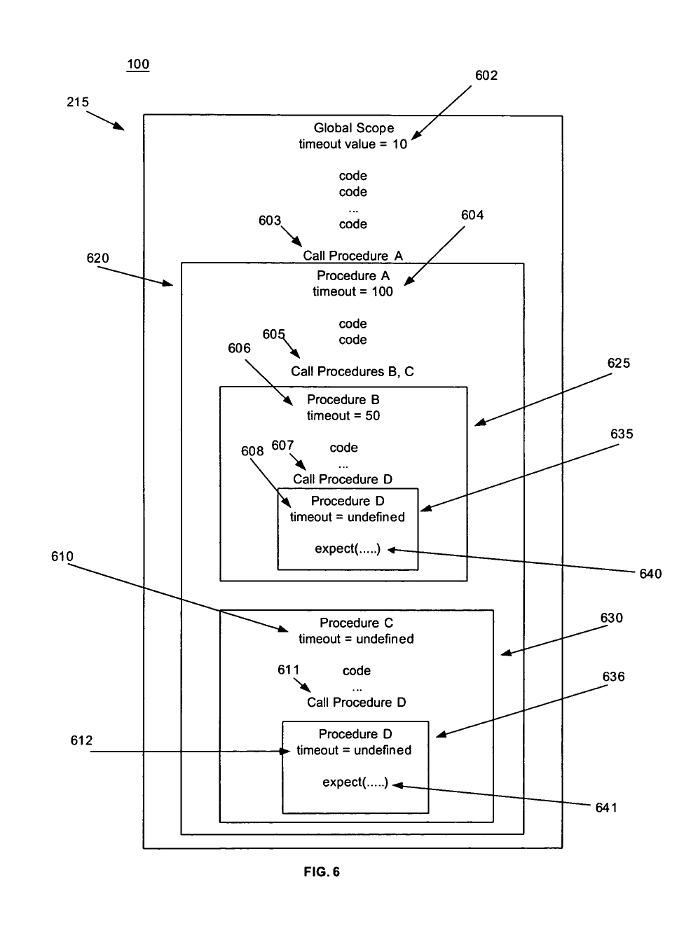

Referring to FIG. 6, the program 215 comprises procedures 620, 625, 630, 635, and 636. The program 215 comprises a first assignment to the timeout variable at the global scope at code line 602. For example, the program 215 assigns the value (10 seconds) to the timeout variable. The program 215 calls the procedure 620 at code line 603. The program 215 nests the procedure 620 by invoking the procedure 620.

The procedure 620 comprises a second assignment to the timeout variable at the global scope at code line 604. For example, the procedure 620 assigns the value (100 seconds) to the timeout variable. The procedure 620 calls the procedures 625 and 630 at code line 605. The procedure 620 nests the procedures 625 and 630 by invoking the procedures 625 and 630.

The procedure 625 comprises a third assignment to the timeout variable at the global scope at code line 606. For example, the procedure 625 assigns the value (50 seconds) to the timeout variable. The procedure 625 calls a first instance of the procedure 635 at code line 607. The procedure 625 nests the procedure 635 by invoking the procedure 635.

The procedure 630 omits the assignment of the value, to the timeout variable at the global scope as is indicated by exemplary code line 610. The procedure 630 calls a second instance of the procedure 635, for example, the procedure 636, at code line 611. The procedure 630 nests the procedure 636 by invoking the procedure 636.

The procedures 635 and 636 (e.g., the first and second instances of the procedure 635) omit the assignment of the value to the timeout variable at the global scope as is indicated by exemplary code lines 608 and 612, respectively. The procedures 635 and 636 comprise respective expect statements 640 and 641. During execution of the expect statements 640 and/or 641, the expect module 205 invokes the traversal module 210 to automatically determine the value of the timeout variable associated with the procedures 635 and/or 636, respectively.

Exemplary detail of the traversal module 210 is now presented, for illustrative purposes. The traversal module 210 employs a procedure hierarchy associated with the procedure that comprises the expect statement, for example, the procedure 636 that comprises the expect statement 641, to automatically determine the value of the timeout variable associated with the expect statement 641. The traversal module 210 establishes the procedure hierarchy based on a set of one or more nested procedures of the one or more procedures of the program 215 that are invoked to reach the procedure 636. Each one of the set of one or more nested procedures comprises a respective scope (e.g., a local scope) and adds a respective level to the procedure hierarchy. For example, the procedure 620 calls the procedure 625. The procedure 625 calls the procedure 635. The procedures 620 and 625 comprise the set of one or more nested procedures that comprise the procedure hierarchy for the procedure 635.

Where the expect module 205 determines that the value of the timeout variable is undefined within the procedure 636 (i.e., as is indicated by the exemplary code line 610), the expect module 205 invokes the traversal module 210. The traversal module 210 traverses backwards through the set of one or more nested procedures in the procedure hierarchy to identify the value associated with the expect statement 641 of the procedure 636. The traversal module 210 traverses through one or more of the set of one or more nested procedures until an identification of the value associated with the expect statement 641 of the procedure 636. The traversal module 210 serves to identify of the value associated with the expect statement 641 of the procedure 636 by determining if the timeout variable is assigned the value. The traversal module 210 determines the value of the variable (e.g., the timeout variable) that is defined within the respective scope of one nested procedure of the set of one or more nested procedures in the procedure hierarchy associated with the procedure 636. The traversal module 210 determines the occurrence of the identification of the value by identifying a most recently defined value in relation to the procedure 636, for example, the value first identified by the traversal module 210 in traversing backwards through the procedure hierarchy associated with the procedure 636. The traversal module 210 returns to the expect module 205 the most recently defined value in relation to the procedure 636.

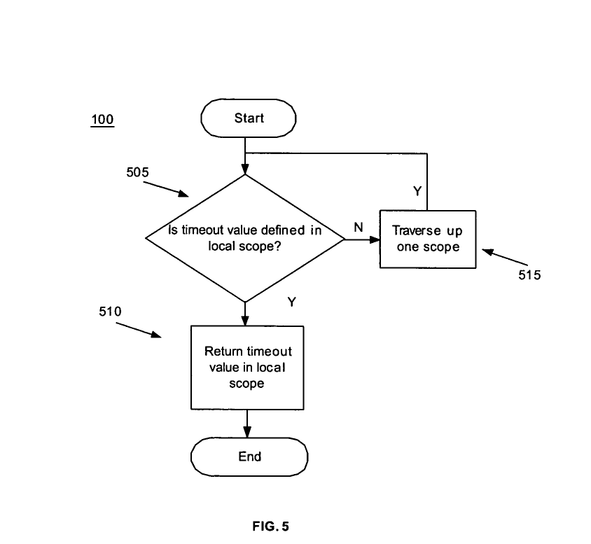

Referring to FIGS. 2 and 5-6, in STEP 505 the traversal module 210 determines if the timeout value is defined within the local scope of a called procedure, for example, the procedure 635. In STEP 510, if the value of the timeout variable is defined within the procedure 636, the traversal module 210 returns the value defined within the local scope of the procedure 636. In STEP 515, where the value of the timeout variable is undefined within the local scope of the called procedure 636, the traversal module 210 identifies from the procedure hierarchy a calling procedure, for example, the procedure 630, by traversing backwards through the procedure hierarchy associated with the procedure 636.

In one example, the traversal module 210 employs a change scope command, for example, an uplevel command of the Expect scripting language, to traverse backwards from the called procedure (e.g., the procedure 636) to the calling procedure (e.g., the procedure 630) and to change the scope to a second scope associated with the calling procedure. The traversal module 210 determines if the value of the timeout variable is defined within the local scope associated with the calling procedure. In STEPS 505 and 515, the traversal module 210 continues to traverse the procedure hierarchy associated with the procedure 636 to identify the value of the timeout variable associated with the expect statement 641 of the procedure 636 where the value of the timeout variable is undefined within the local scope associated with the calling procedure. Where the value of the variable, for example, the timeout variable, is undefined in the procedure hierarchy, the traversal module 210 returns the value of the timeout variable defined at the global scope associated with the program 215. Where the global timeout value is undefined, the traversal module 210 returns a default value, for example, a default timeout value.

Referring to FIGS. 2 and 6, during execution of the program 215 on the processor 230, the program 215 calls the procedure 620. The procedure 620 calls the procedures 625 and 630. The procedure 625 calls the procedure 635. The procedure 630 calls the procedure 636. The procedure 635 executes the expect statement 641. The host system 105 invokes the expect module 205 upon execution of the expect statement 641. The expect module 205 invokes the traversal module 210 to automatically determine the value of the timeout variable associated with the expect statement 641.

The traversal module 210 determines that the value of the timeout variable is undefined within the local scope of the procedure 636. The traversal module 210 invokes the uplevel command to traverse backwards through the procedure hierarchy associated with the procedure 636. The traversal module 210 invokes the uplevel command to change the scope to the local scope of the calling procedure (e.g., the procedure 630) to the procedure 636. The traversal module 210 determines that the value of the timeout variable is undefined within the local scope of the procedure 630. The traversal module 210 invokes the uplevel command to change the scope to the local scope of the calling procedure to the procedure 630, for example, the procedure 620. The traversal module 210 determines that the value of the timeout variable is defined within the local scope of the procedure 620 (e.g., the procedure A) and returns the value, for example, 100 seconds, to the expect module 205.

The expect module 205 employs the value returned by the traversal module 210 to assign the value of the timeout variable at the global level. The expect module 205 invokes the Expect scripting language to execute the expect statement 641. The expect statement 641 employs the value of the timeout variable at the global scope (i.e., the value returned from the traversal procedure 210, 100 seconds) to limit the duration of time to wait for the one or more responses from the remote system 110. Upon receipt of the one or more responses from the remote system 100, the expect module 205 in one example evaluates any return values from the execution of the expect statement 641 by the Expect scripting language and logs any errors.

In another example, upon execution of the expect statement 640 of the procedure 635, the expect module 205 invokes the traversal module 210. The traversal module 210 determines that the value of the timeout variable is undefined within the local scope associated with the procedure 635 (e.g., the first instance of the Procedure D). The traversal module 210 traverses backwards one level (e.g. the traversal module 210 employs the change scope command, the uplevel command of the Expect scripting language) and changes the scope to the local scope of the calling procedure, the procedure 625 (e.g., the Procedure B). The traversal module 210 determines that the timeout value associated with the expect statement 640 is defined within the local scope of the procedure 625 (e.g., the Procedure B) in the code line 606, comprising a value of fifty seconds, and returns the value of the code line 606 to the expect module 205.

The apparatus 100 in one example employs one or more computer-readable signal-bearing media. Examples of a computer-readable signal-bearing medium for the apparatus 100 comprise the recordable data storage medium 225 of the host system 105. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method, comprising the step of:
obtaining a value, of one or more values from one or more nested procedures, for a variable that is undefined within one procedure that is nested within the one or more nested procedures.

2. The method of claim 1, further comprising the step of automatically determining the value from the one or more nested procedures.

3. The method of claim 1, further comprising the step of assigning the value to the variable that is undefined within the one procedure.

4. The method of claim 1, further comprising the steps of:
establishing a procedure hierarchy that comprises the one procedure and the one or more nested procedures; and
determining from the procedure hierarchy the value for the variable that is undefined within the one procedure.

5. The method of claim 4, wherein the value of the variable that is undefined in the one procedure comprises a most recently defined value in relation to the one procedure, wherein the step of determining comprises the steps of:
traversing the procedure hierarchy;
identifying from the procedure hierarchy, the most recently defined value in relation to the one procedure; and
returning to the one procedure, the most recently defined value in relation to the one procedure.

6. The method of claim 5, wherein the value comprises a first value, wherein the step of traversing comprises the steps of:
determining that the variable that is undefined within the one procedure is undefined within a first scope associated with the one procedure;
identifying from the procedure hierarchy, one nested procedure that calls the one procedure;
determining that the variable that is undefined within the one procedure is defined within a second scope associated with the one nested procedure, wherein the variable that is undefined with the one procedure is defined by a second value associated with the second scope; and
returning to the variable that is undefined within the one procedure, the second value associated with the second scope associated with the one nested procedure.

7. The method of claim 6, further comprising the steps of:
identifying from the procedure hierarchy, a second nested procedure that calls the one nested procedure upon determination that the variable that is undefined within the one procedure is undefined within the second scope associated with the one nested procedure; and
assigning a default value to the variable that is undefined within the one procedure, wherein the variable that is undefined within the one procedure is undefined within the one or more nested procedures in the procedure hierarchy associated with the one procedure.

8. The method of claim 5, further comprising the step of:
traversing the procedure hierarchy until an identification of the most recently defined value in relation to the one procedure.

9. The method of claim 1, wherein the one procedure comprises the one or more expect statements, the method further comprising the step of:
limiting to the value, a duration of time to wait for one or more responses associated with the one or more expect statements.

10. The method of claim 9, further comprising the steps of:
determining an expiration of the duration of time to wait for the one or more responses associated with the one or more expect statements;
associating the value of the variable that is undefined within the one procedure with the one or more expect statements of the one or more expect statements;
maintaining a timer associated with the one expect statement; and
evaluating the timer and the value of the variable that is undefined within the one procedure to determine the expiration of the duration of time associated with the one expect statement.

11. The method of claim 1, wherein the one procedure comprises one or more expect statements, the method further comprising the steps of:
executing the one or more expect statements;
waiting for the one or more responses associated with the one or more expect statements; and
executing one or more actions associated with the one or more expect statements upon failure to receive the one or more responses before an expiration of a duration of time.

12. The method of claim 1, further comprising the steps of:
invoking a program that comprises one or more expect statements from a host system;
establishing a communication with a remote system;
executing on the remote system one or more commands associated with the one or more expect statements of the program;
receiving one or more responses associated with the one or more commands before an expiration of a duration of time to wait for the one or more responses; and
processing the one or more responses.

13. The method of claim 12, wherein the program comprises the one procedure and the one or more nested procedures, wherein the one procedure comprises the one expect statement, wherein the step of invoking comprises the steps of:
executing from the program, the one procedure;
invoking an expect module upon executing the one expect statement;
obtaining the value for the variable that is undefined within the one procedure from the one or more nested procedures;
associating the value for the variable that is undefined within the one procedure with the one expect statement; and
limiting to the value for the variable that is undefined within the one procedure, the duration of time to wait for the one or more responses from the remote system.

14. The method of claim 13, wherein the step of invoking the expect module comprises the steps of:
invoking a traversal module;
employing the traversal module to traverse a procedure hierarchy to identify the value for the variable that is undefined within the one procedure associated with the one expect statement of the one procedure; and
returning the value for the variable that is undefined within the one procedure associated with the one expect statement of the one procedure to the expect module.

15. The method of claim 13, wherein the value of the variable that is undefined within the one procedure comprises a most recently defined value in the procedure hierarchy in relation to the one procedure, wherein the step of obtaining comprises the steps of:
determining if the value for the variable that is undefined within the one procedure is defined within a scope associated with the one procedure;
traversing a procedure hierarchy wherein the value for the variable that is undefined within the one procedure is undefined in the scope of the one procedure; and
returning to the one procedure, the most recently defined value in the procedure hierarchy in relation to the one procedure.

16. The method of claim 15, wherein the scope comprises a first scope, wherein the step of traversing the procedure hierarchy comprises the steps of:
associating with the one procedure, one nested procedure of the one or more nested procedures in the procedure hierarchy, wherein the one nested procedure calls the one procedure;
employing a change scope command to traverse from the first scope associated with the one procedure to a second scope associated with the one nested procedure; and
determining if the variable that is undefined within the one procedure is undefined within the second scope associated with the one nested procedure.

17. The method of claim 16, further comprising the steps of:
traversing the one or more nested procedures in the procedure hierarchy upon determination that the variable that is undefined within the one procedure is undefined within the second scope associated with the one nested procedure; and
assigning a default value to the variable that is undefined within the one procedure, wherein the variable that is undefined within the one procedure is undefined within the one or more nested procedures in the procedure hierarchy associated with the one procedure.

18. An apparatus, comprising:
a traversal module that identifies a value for a variable associated with one procedure, from one or more values associated with one or more nested procedures, wherein the variable is undefined within the one procedure, wherein the one procedure is nested in the one or more nested procedures.

19. The apparatus of claim 18, wherein the traversal module traverses through the one or more nested procedures associated with the one procedure until an identification of the value associated with the one procedure within one of the one or more nested procedures associated with the one procedure.

20. The apparatus of claim 18, further comprising:
an expect module that executes an expect statement and employs the value to limit a duration of time to wait for one or more responses.

21. The apparatus of claim 20, wherein the value is defined within a scope of one nested procedure of the one or more nested procedures.

22. The apparatus of claim 21, wherein the expect module extends the Expect scripting language to obtain the value for the variable from the one nested procedure of the one or more nested procedures;
wherein the expect module employs the Expect scripting language to evaluate the one expect statement based on the value from the one nested procedure of the one or more nested procedures.

23. The apparatus of claim 21,
wherein the expect module determines that the variable is undefined within a scope associated with the one expect statement;
wherein the expect module invokes the traversal module to obtain the value for the variable that is undefined within the scope associated with the one expect statement, wherein the expect module limits to the value a duration of time to wait for one or more responses associated with the one expect statement to the value.

24. An article, comprising:
one or more computer-readable signal-bearing media;
means in the one or more media for obtaining a value of one or more values from one or more nested procedures, for a variable that is undefined within one procedure that is nested within the one or more nested procedures.

25. The article of claim 24, further comprising:
means in the one or more media for automatically determining the value for the variable that is undefined within the one procedure from the one or more nested procedures; and
means in the one or more media for assigning the value for the variable that is undefined within the one procedure to the variable that is undefined within the one procedure.

26. The article of claim 24, further comprising:
means in the one or more media for establishing a procedure hierarchy comprising the one procedure and the one or more nested procedures; and
means in the one or more media for determining the value for the variable that is undefined within the one procedure from the procedure hierarchy.

27. The article of claim 26, wherein the value comprises a most recently defined value in relation to the one procedure, the article comprising:
means in the one or more media for traversing the procedure hierarchy;
means in the one or more media for identifying from the procedure hierarchy, the most recently defined value in relation to the one procedure; and
means in the one or more media for returning the most recently defined value in relation to the one procedure to the one procedure.

28. The article of claim 27, further comprising:
means in the one or more media for traversing the procedure hierarchy until identifying the most recently defined value in relation to the one procedure.

29. The article of claim 24, further comprising:
means in the one or more media for limiting to the value for the variable that is undefined within the one procedure, a duration of time to wait for one or more responses associated with one expect statement of one or more expect statements, wherein the one procedure comprises the one or more expect statements.
